(19) United States
(12) Patent Application Publication
(10) Pub. No.: US 2024/0344848 A1
(43) Pub. Date: Oct. 17, 2024

(54) ROUTE PLANNING AND TRIP MONITORING SYSTEM FOR HIGH DEFINITION MAP DATA COLLECTION

(71) Applicant: TuSimple, Inc., San Diego, CA (US)

(72) Inventors: Wan-Ting Hung, Dublin, CA (US); Anping Wang, San Diego, CA (US); Ke Xu, San Diego, CA (US); Yilang XU, San Diego, CA (US); Karl WANG, San Diego, CA (US)

(21) Appl. No.: 18/618,453

(22) Filed: Mar. 27, 2024

Related U.S. Application Data
(60) Provisional application No. 63/493,160, filed on Mar. 30, 2023.

(51) Int. Cl. G01C 21/00; G01C 21/36

(52) U.S. Cl. CPC G01C 21/3896; G01C 21/367; G01C 21/3676

(57) ABSTRACT

The present disclosure provides a data processing system, method, and device for monitoring a high definition map data collection trip. A current vehicle location is determined. Whether the vehicle is following a planned route linked to a data collection trip, based on the current vehicle location is determined. On a condition that the vehicle is not following the planned route, a reason why the vehicle is not following the planned route is determined. An alert is generated, displayed on an in-vehicle navigation device, and uploaded with the reason to a command center.

### CROSS-REFERENCE TO RELATED APPLICATIONS

The disclosure claims the benefits of priority to U.S. Provisional Application No. 63/493,160, filed on Mar. 30, 2023, which is incorporated herein by reference in its entirety.

### TECHNICAL FIELD

This document relates to systems, apparatus, and methods for route planning and trip monitoring during a high definition map data collection trip.

### BACKGROUND

For the last 100 years, the prospect of autonomous driving has captured the imagination of scientists and automotive engineers alike. One challenge for autonomous driving is the ability to determine the position of a vehicle in real-time.

### SUMMARY

Autonomous vehicles include devices that can operate to facilitate autonomous driving along a trajectory.

In some embodiments, a method for route planning for high definition map data collection is provided. The method includes selecting a portion of a digital map that includes a route to be linked to a data collection trip; drawing the route on the digital map portion using a graphical user interface tool; adding electronic navigation instructions to the route on the digital map portion; saving the route and the electronic navigation instructions to a central storage; and distributing the route and the electronic navigation instructions from the central storage to an in-vehicle navigation device of a vehicle performing the data collection trip.

In some embodiments, a system for route planning for high definition map data collection is provided. The system includes a user console including a display and a processor, a command center including a central storage and a processor, and a vehicle including an in-vehicle navigation device. The processor in the user console is configured to select a portion of a digital map that includes a route to be linked to a data collection trip; draw the route on the digital map portion using a graphical user interface tool; add electronic navigation instructions to the route on the digital map portion; and save the route and the electronic navigation instructions to a central storage in a command center. The processor in the command center is configured to distribute the route and the electronic navigation instructions from the central storage to the in-vehicle navigation device of the vehicle performing the data collection trip.

In some embodiments, a system for monitoring a high definition map data collection trip is provided. The system includes an in-vehicle navigation device including a display and a processor and a command center. The processor in the in-vehicle navigation device is configured to determine a current vehicle location and determine whether the vehicle is following a planned route linked to a data collection trip, based on the current vehicle location. On a condition that the vehicle is not following the planned route, the processor in the in-vehicle navigation device is configured to determine a reason why the vehicle is not following the planned route; generate an alert; display the alert on the in-vehicle navigation device; and upload the alert and the reason to the command center.

In some embodiments, a method for monitoring a high definition map data collection trip is provided. The method includes determining a current vehicle location and determining whether the vehicle is following a planned route linked to a data collection trip, based on the current vehicle location. On a condition that the vehicle is not following the planned route, the method includes determining a reason why the vehicle is not following the planned route; generating an alert; displaying the alert on an in-vehicle navigation device; and uploading the alert and the reason to a command center.

In some embodiments, the above-described methods are embodied in a non-transitory computer readable storage medium comprising code that when executed by a processor, causes the processor to perform the methods described herein.

In some embodiments, a device that is configured or operable to perform the above-described methods is disclosed.

The above and other aspects and their implementations are described in greater detail in the drawings, the descriptions, and the claims.

### BRIEF DESCRIPTION OF THE DRAWINGS

FIG. 1 shows a block diagram of an example vehicle ecosystem in which

autonomous driving operations can be determined, according to some embodiments of the present disclosure.

FIG. 2 shows a block diagram of components of an exemplary route planning and trip monitoring system, according to some embodiments of the present disclosure.

FIG. 3 shows an exemplary implementation of the route planning and trip monitoring system shown in FIG. 2, according to some embodiments of the present disclosure.

FIG. 4 shows an exemplary user interface of a route planning tool, according to some embodiments of the present disclosure.

FIG. 5 shows a flowchart of an exemplary method for route planning, according to some embodiments of the present disclosure.

FIG. 6 shows an exemplary user interface of an in-vehicle navigation device, according to some embodiments of the present disclosure.

FIG. 7 shows a flowchart of an exemplary method for trip monitoring, according to some embodiments of the present disclosure.

### DETAILED DESCRIPTION

Reference will now be made in detail to exemplary embodiments, examples of which are illustrated in the drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses, systems, and methods consistent with aspects related to subject matter that may be recited in the appended claims.

Driverless cars are now roaming the streets in test condition, while autonomous vehicles are operational and allow traveling without some form of human input. Yet many hurdles still remain for autonomous driving. One challenge for autonomous driving is the ability to determine the exact position of a vehicle in real-time. GPS solutions cannot keep up with autonomous vehicles, as they do not provide data that is sufficiently dynamic and accurate. For instance, GPS solutions do not provide a detailed inventory of road features and objects on the side of the road, nor do they extend the vision of autonomous vehicles to help with navigation.

To help overcome this issue, data collection vehicles have been used for gathering data for high definition map data collection. This collected data can be provided in some form to an autonomous vehicle to help it localize itself with high precision, allowing it to map its exact location with respect to the surrounding environment. With that said, challenges still remain with respect to obtaining sufficient high definition map data.

The methods and systems described herein make it easier for a high definition map data collection route to be planned, enable more precise instructions (e.g., lane-specific instructions) to be provided to the vehicle driver, lead to fewer errors in the data gathering (e.g., fewer errors in circumstances where a planned direction was missed), and increase vehicle driver safety (e.g., by providing advance notice of upcoming planned directions such as lane changes and turns), and uses an automated process to provide real-time status information about the location of the vehicle with respect to collecting the data.

For safe operation of an autonomous vehicle, high definition map data (i.e., lane-specific data) is needed. Due to the range of the various sensors associated with the data collection vehicle (e.g., LIDAR, radar, or cameras, as will be described further below), it may be necessary for the data collection vehicle to travel the same route multiple times to gather the requisite level of detail needed for the high definition map. For example, if a high definition map is to be created for a section of a four-lane wide highway, it may be necessary to have the vehicle drive the same section of the highway in each lane. For example, a first trip is taken in the leftmost lane of the section, a second trip is taken in the second lane from the left of the section, a third trip is taken in the third lane from the left of the section, and a fourth trip is taken in the fourth lane from the left of the section (i.e., the rightmost lane). If on any of those four trips, the vehicle is not in the designated lane for the entire section, that trip may need to be repeated to ensure that the correct data has been collected. For example, if on the fourth trip there is a disabled vehicle in the rightmost lane, the data collection vehicle will need to change lanes to continue operating safely. However, there will be a gap in the map data for the portion of the fourth trip that the data collection vehicle was not in the rightmost lane, so at least that portion of the fourth trip will need to be repeated to fill in the gap in the map data.

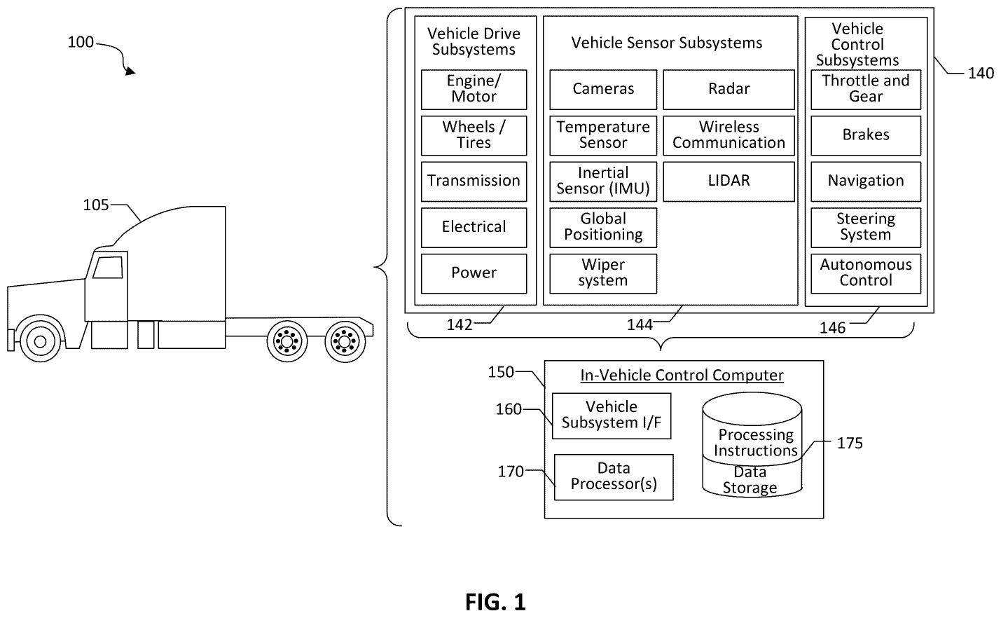

FIG. 1 shows a block diagram of an example vehicle ecosystem 100 in which autonomous driving operations can be determined, according to some embodiments of the present disclosure. As shown in FIG. 1, a vehicle 105 may be a semi-trailer truck. The vehicle ecosystem 100 includes several systems and components that can generate or deliver one or more sources of information/data and related services to an in-vehicle control computer 150 that may be located in a vehicle 105. The in-vehicle control computer 150 can be in data communication with a plurality of vehicle subsystems 140, all of which can be resident in the vehicle 105. A vehicle subsystem interface 160 is provided to facilitate data communication between the in-vehicle control computer 150 and the plurality of vehicle subsystems 140. In some embodiments, the vehicle subsystem interface 160 can include a controller area network (CAN) controller to communicate with devices in the vehicle subsystems 140.

The vehicle 105 may include various vehicle subsystems that support the operation of vehicle 105. The vehicle subsystems may include a vehicle drive subsystem 142, a vehicle sensor subsystem 144, or a vehicle control subsystem 146. The components or devices of the vehicle drive subsystem 142, the vehicle sensor subsystem 144, and the vehicle control subsystem 146 are shown as examples. The vehicle drive subsystem 142 may include components operable to provide powered motion for the vehicle 105. For example, the vehicle drive subsystem 142 may include an engine or motor, wheels/tires, a transmission, an electrical subsystem, and a power source.

The vehicle sensor subsystem 144 may include a number of sensors configured to sense information about an environment or condition of the vehicle 105. The vehicle sensor subsystem 144 may include one or more cameras or image capture devices, one or more temperature sensors, an inertial measurement unit (IMU), a Global Positioning System (GPS) transceiver, a laser range finder/LIDAR unit, a radar unit, or a wireless communication unit (e.g., a cellular communication transceiver). The vehicle sensor subsystem 144 may also include sensors configured to monitor internal systems of the vehicle 105 (e.g., an O₂ monitor, a fuel gauge, an engine oil temperature, etc.).

The IMU may include any combination of sensors (e.g., accelerometers and gyroscopes) configured to sense position and orientation changes of the vehicle 105 based on inertial acceleration. The GPS transceiver may be any sensor configured to estimate a geographic location of the vehicle 105. For this purpose, the GPS transceiver may include a receiver/transmitter operable to provide information regarding the position of the vehicle 105 with respect to the Earth. The radar unit may represent a system that utilizes radio signals to sense objects within the local environment of the vehicle 105. In some embodiments, in addition to sensing the objects, the radar unit may additionally be configured to sense the speed and the heading of the objects proximate to the vehicle 105. The laser range finder or LIDAR unit may be any sensor configured to sense objects in the environment in which the vehicle 105 is located using lasers. The cameras may include one or more devices configured to capture a plurality of images of the environment of the vehicle 105. The cameras may be still image cameras or motion video cameras.

The vehicle control subsystem 146 may be configured to control operation of the vehicle 105 and its components. Accordingly, the vehicle control subsystem 146 may include various elements such as a throttle and gear, a brake unit, a navigation unit, a steering system or an autonomous control unit. The throttle may be configured to control, for instance, the operating speed of the engine and, in turn, control the speed of the vehicle 105. The gear may be configured to control the gear selection of the transmission. The brake unit can include any combination of mechanisms configured to decelerate the vehicle 105. The brake unit can use friction to slow the wheels in a standard manner. The brake unit may include an Anti-lock brake system (ABS) that can prevent the brakes from locking up when the brakes are applied. The navigation unit may be any system configured to determine a driving path or route for the vehicle 105. The navigation unit may additionally be configured to update the driving path dynamically while the vehicle 105 is in operation. In some embodiments, the navigation unit may be configured to incorporate data from the GPS transceiver and one or more predetermined maps so as to determine the driving path for the vehicle 105. The steering system may represent any combination of mechanisms that may be operable to adjust the heading of vehicle 105 in an autonomous mode or in a driver-controlled mode.

The autonomous control unit may represent a control system configured to identify, evaluate, and avoid or otherwise negotiate potential obstacles in the environment of the vehicle 105. In general, the autonomous control unit may be configured to control the vehicle 105 for operation without a driver or to provide driver assistance in controlling the vehicle 105. In some embodiments, the autonomous control unit may be configured to incorporate data from the GPS transceiver, the radar, the LIDAR, the cameras, or other vehicle subsystems to determine the driving path or trajectory for the vehicle 105.

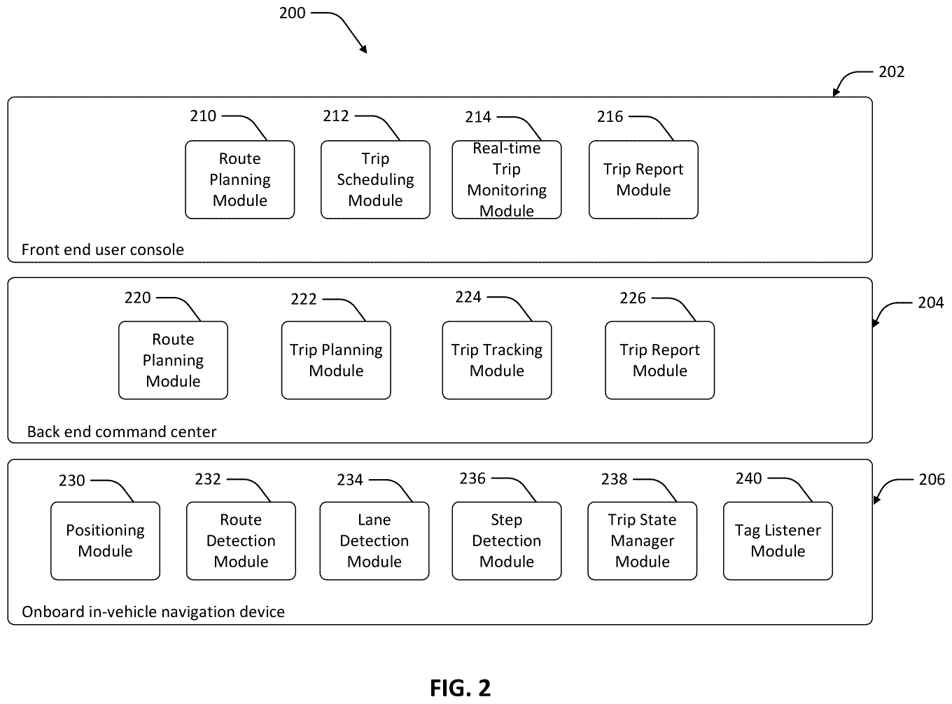

Many or all of the functions of the vehicle 105 can be controlled by the in-vehicle control computer 150. The in-vehicle control computer 150 may include at least one data processor 170 (which can include at least one microprocessor) that executes processing instructions stored in a non-transitory computer readable medium, such as the data storage device 175 or memory. The in-vehicle control computer 150 may also represent a plurality of computing devices that may serve to control individual components or subsystems of the vehicle 105 in a distributed fashion. In some embodiments, the data storage device 175 may contain processing instructions (e.g., program logic) executable by the data processor 170 to perform various methods or functions of the vehicle 105, including those described for the various modules described in FIGS. 2-7 as further explained herein.

The data storage device 175 may contain additional instructions as well, including instructions to transmit data to, receive data from, interact with, or control one or more of the vehicle drive subsystem 142, the vehicle sensor subsystem 144, and the vehicle control subsystem 146. The in-vehicle control computer 150 can be configured to include a data processor 170 and a data storage device 175. The in-vehicle control computer 150 may control the function of the vehicle 105 based on inputs received from various vehicle subsystems (e.g., the vehicle drive subsystem 142, the vehicle sensor subsystem 144, and the vehicle control subsystem 146).

FIG. 2 shows a block diagram of components of an exemplary route planning and trip monitoring system 200, according to some embodiments of the present disclosure. The system 200 may include a front end user console 202, a back end command center 204, and an onboard in-vehicle navigation device 206. The user console 202 may be implemented as a computer (e.g., a desktop computer or a laptop computer) in communication with the command center 204. The command center 204 may be implemented as a computer (e.g., a server, a desktop computer, or a laptop computer) in communication with the user console 202 and the in-vehicle navigation device 206. The in-vehicle navigation device 206 may be implemented as a touch-screen device, such as a tablet, and is configured to be placed in a vehicle such that a driver of the vehicle may interact with the in-vehicle navigation device 206 while driving the vehicle.

The user console 202 may include a processor configured to perform several functions, including a route planning module 210, a trip scheduling module 212, a real-time trip monitoring module 214, and a trip report module 216. It is noted that the different modules 210-216 may be implemented as hardware (e.g., an application-specific integrated circuit (ASIC)), as software, or as a combination of hardware and software. The route planning module 210 may be used to plan a route for a driver of a vehicle to follow, for example, in connection with data gathering for high definition map data collection. The trip scheduling module 212 may be used to schedule a data gathering trip for high definition map data collection, for example, after the route has been planned in the route planning module 210. The real-time trip monitoring module 214 may be used to monitor a vehicle in real-time while the vehicle is traveling on a data gathering trip for high definition map data collection, for example, and may be used to determine whether the vehicle is following the planned route, as will be described in greater detail below. The trip report module 216 may receive gathered data about the data gathering trip for high definition map data collection from the in-vehicle navigation device 206 (either directly from the in-vehicle navigation device 206 or via the command center 204) after the trip has been completed. The trip report module 216 may also be configured to analyze the actual route taken by the vehicle after the trip has been completed to highlight possible areas on the planned route where the vehicle driver did not strictly follow the planned route.

The command center 204 may include a processor configured to perform several functions, including a route planning module 220, a trip planning module 222, a trip tracking module 224, and a trip report module 226. It is noted that the different modules 220-226 may be implemented as hardware (e.g., an application-specific integrated circuit (ASIC)), as software, or as a combination of hardware and software. The route planning module 220 may be used in conjunction with the user console 202 and the route planning module 210 to plan a route for a driver of a vehicle to follow, for example, in connection with data gathering for high definition map data collection. The trip planning module 222 may be used in conjunction with the user console 202 and the trip scheduling module 212 to schedule a data gathering trip for high definition map data collection, for example, after the route has been planned in the route planning module 220.

The trip tracking module 224 may be used in conjunction with the user console 202 and the real-time trip monitoring module 214 to monitor a vehicle in real-time while the vehicle is traveling on a data gathering trip for high definition map data collection, for example. The trip tracking module 224 may be configured to receive status messages from the in-vehicle navigation device 206. For example, the status messages may include the current vehicle position or a state change message, such as whether the vehicle has changed lanes or has deviated from the planned route. The trip report module 226 may be used in conjunction with the user console 202 and the trip report module 216 to receive gathered data about the data gathering trip for high definition map data collection from the in-vehicle navigation device 206 after the trip has been completed.

The in-vehicle navigation device 206 may include a display and a processor configured to perform several functions, including a positioning module 230, a route detection module 232, a lane detection module 234, a step detection module 236, a trip state manager module 238, and a tag listener module 240. It is noted that the different modules 230-240 may be implemented as hardware (e.g., an application-specific integrated circuit (ASIC)), as software, or as a combination of hardware and software. The positioning module 230 may be used to determine a current position of the vehicle. For example, the positioning module may use a high-precision GPS module to detect the vehicle's current location, either by including the GPS module or by being in communication with the GPS module. The positioning module 230 may periodically output the vehicle's current position, for example, every second or another predetermined time interval.

The route detection module 232 may be used to determine whether the vehicle is on the route planned by the route planning modules 210, 220. The route detection module 232 may receive the vehicle's current position (for example, from the positioning module 230) and may periodically update an internal status of whether the vehicle is on the planned route (for example, every two seconds or other predetermined time interval). The route detection module 232 may output whether the vehicle is on the planned route on demand (for example, in response to a request) or periodically.

The lane detection module 234 may be used to determine which lane on a road the vehicle is currently traveling in. For example, the lane detection module 234 may know the vehicle's current position on the road and the lane width, and based on those values, calculate which lane that the vehicle is currently traveling in. For example, the lane detection module 234 may compute the distance between the current vehicle position and a midline of the leftmost lane of the road, then integer divide the distance by the lane width. The quotient is the lane that the vehicle is currently located in, with the leftmost lane having an index of 0.

The route detection module 232 and the lane detection module 234 may work in conjunction with each other to help determine whether the vehicle is following the planned route. For example, the planned route may indicate that the vehicle is supposed to be traveling in the third lane from the left on a four lane-wide highway. But if there is an obstacle preventing the driver from being in the third lane from the left at the designated location (for example, there may be another vehicle, an accident, or road hazard that prevented the driver from being in the third lane from the left), this would be detected as a deviation from the route. Additional details on route deviation are provided elsewhere in this disclosure.

The step detection module 236 may be used to track the vehicle's movement and compare it to the pre-determined navigation instructions. For example, as the vehicle approaches a navigation instruction, such as a turn or intersection, the step detection module 236 detects the upcoming change and presents a modal (for example, a pop-up alert on the in-vehicle navigation device 206) to alert the driver of the upcoming turn.

The trip state manager module 238 may be used to manage the state of the data collection trip, including starting, pausing, resuming, and ending trips. The trip state manager module 238 also stores a trip identifier (for example, an alphanumeric string) and details such as the trip's route and all steps of the route.

The tag listener module 240 may be used to enable a driver to tag geospatial information while driving the vehicle. The tag listener module 240 may present a user interface on the in-vehicle navigation device 206 that allows the driver to quickly and easily input information by voice, such as the start of rain, the presence of an emergency lane vehicle, or any other relevant information. The tag listener module 240 uses GPS to provide accurate location data and utilizes wireless connectivity to transmit data to the command center 204 in real-time. The command center 204 can receive the data transmitted by the onboard module, analyze the information, and make decisions in real-time. The tag listener module 240 is designed to provide a feedback loop that enables the driver to improve the quality of the data collected, ensuring that the information transmitted to the command center 204 is accurate and useful.

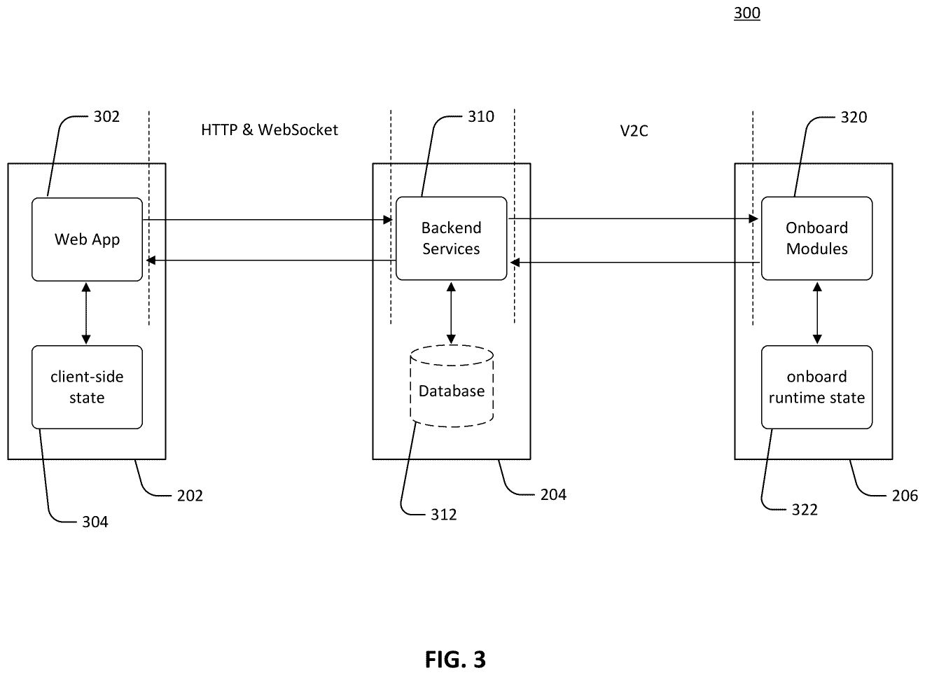

FIG. 3 shows an exemplary implementation of the route planning and trip monitoring system shown in FIG. 2, according to some embodiments of the present disclosure. The data collection platform 300 includes the front end user console 202, the back end command center 204, and the onboard in-vehicle navigation device 206. The user console 202 may be implemented as a web application (“web app”) 302 with a local memory 304 configured to store local (i.e., “client-side”) state information. The command center 204 may be implemented as one or more backend services 310 that stores states as data in a database 312, which serve as a single source of truth in the platform 300. The in-vehicle navigation device 206 may be implemented as one or more onboard modules 320 with a local memory 322 configured to store onboard runtime state information.

During the trip monitoring phase, frequent communication between the user console 202, the command center 204, and the in-vehicle navigation device 206 can lead to frequent state updates, whereas each component needs to maintain its state and align with the other two components. For example, a command triggered by a user in the web application 302 can lead to a data update in the database 312 managed by the backend services 310 and in the states 322 managed by the onboard modules 320. As another example, a vehicle state update from the onboard modules 320 can be synchronized to the backend services 310 and broadcasted to the web application 302. As another example, a rerouting route generated by the backend services 310 can be sent to the onboard modules 320 and the web application 302.

Because the data stored in the database 312 serves as the single source of truth in the platform 300, while the web application 302 and onboard modules 320 only maintain temporary states in memories 304 and 322, they can communicate with the backend services 310 to fetch the latest states and request state updates. But the web application 302 does not communicate directly with the onboard modules 320 and vice versa.

The communication between the backend services 310 and the onboard modules 320 utilizes vehicle to cloud to vehicle communications (V2C). V2C acts like a message queue with message retention. Thus, if the backend services 310 produce multiple messages but the onboard modules 320 lose the network connection or crash at the same time, once the onboard modules 320 recover, they can consume the unconsumed messages in order without any data loss. If an onboard module 320 raises an error or crashes during processing a consumed message, once the onboard module 320 recovers, the message can be consumed again. The same principle applies to the other direction.

The communication between the web application 302 and the backend services 310 are implemented over Hypertext Transfer Protocol (HTTP) and WebSocket. HTTP is used for REpresentational State Transfer (REST) application programming interfaces (APIs) only, while WebSocket is used to allow the backend services 310 to broadcast state updates to the web application 302. In some embodiments, if multiple web applications 302 are running, the backend services 310 can broadcast state updates to all running web applications 302. If the WebSocket server is down or the web application 302 is experiencing an intermittent network connection while the backend services 310 are trying to broadcast messages, unlike V2C, those messages will be lost. However, the web application 302 is able to refetch the latest states by refreshing the page and sending API requests anytime later.

Since both the client-side state in memory 304 and the onboard runtime state in memory 322 are temporary, the web application 302 and the onboard modules 320 are required to fetch the latest states from the backend services 310 to ensure they are synchronized. Refetching the latest states at the beginning of each component's lifecycle will enforce state synchronization before each component turns to running. Both the web application 302 and the onboard modules 320 will not store its states in any form locally for future direct retrieval.

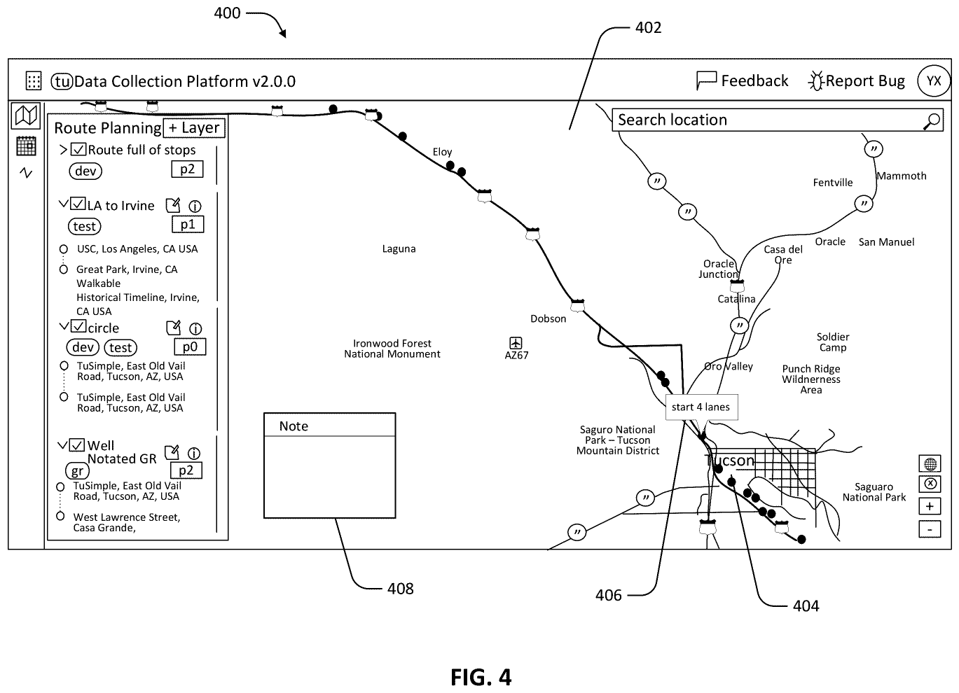

FIG. 4 shows an exemplary user interface 400 of a route planning tool, according to some embodiments of the present disclosure. For example, the route planning tool may be implemented as software running in the user console 202 and may include features of the route planning module 210. The user interface 400 includes a map portion 402. In the map portion 402, a user may use drawing tools to draw a route on the map that the vehicle is to follow. In some embodiments, the drawing tools may be configured to interact with the map such that when the user draws a route on the map, the route automatically follows roads shown on the map. In other embodiments, the user may draw a route on the map and after the route is drawn, the route may be automatically adjusted to be on roads nearest to where the route is drawn. After the route is drawn, the drawing tools may be configured to enable the user to adjust the route, for example, in a drag and drop manner.

An indicator 404 of a note to a driver of the vehicle may appear in the map portion 402 at any location along the route drawn by the user. For example, the note may include a notation such as extra information determined during the route planning phase that the user (i.e., the route planner) wants to provide to the driver at a selected location along the route. The user may view the contents of the note (for example, as shown by note 406) by hovering over the corresponding indicator 404 (for example, the user may hover the cursor over the indicator 404 and the note 406 may appear as a pop-up window). To add a note to the route, the user may activate a user interface element or command to cause a window 408 to appear on the user interface 400. The user may then enter the contents of the note into the window 408, for example, by using a keyboard. In some embodiments, the contents of the note may be predetermined (i.e., the user may select one of several options) and a list of options may be displayed to the user in the window 408 (for example, as a drop-down list or other user interface element by which the user may select one element from the list). When creating the note, it can be associated with a particular location on the route. For example, the location may be identified using a geotag or other form of coordinates to identify the location.

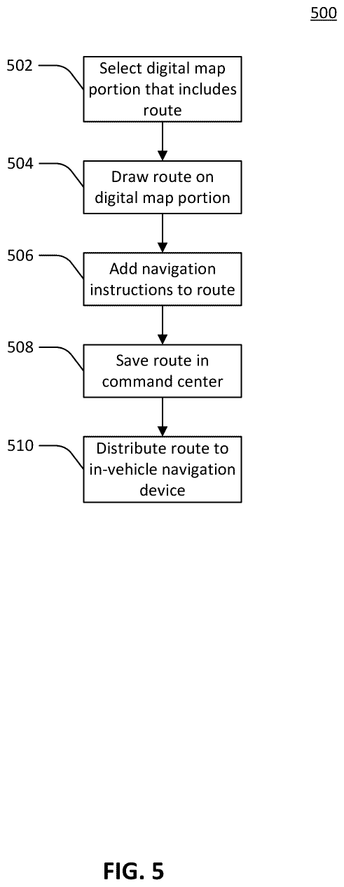

FIG. 5 shows a flowchart of an exemplary method 500 for route planning, according to some embodiments of the present disclosure. The method 500 may be performed by the route planning module 210 and may utilize user interface 400 for the method. The user selects a digital map portion that includes an area where the route is to be drawn (step 502). The user may select the digital map portion, for example, by entering a postal code assigned to the area, entering a place name (e.g., a city name), entering a street address in the area, or by using graphical user interface tools to zoom in on the area. The user draws the route on the selected digital map portion (step 504). For example, the user may draw the route on the map in a manner described above in connection with the user interface 400 shown FIG. 4.

The user adds navigation instructions to the route (step 506). For example, the user may indicate to the driver what lane the driver is supposed to drive the vehicle in at certain points along the route. If the route includes turns, the navigation instructions may include where the turns are to be made. The navigation instructions may also include notes to the driver. For example, if the route is on a multi-lane highway and the number of lanes change (e.g., from three lanes to four lanes), the user may provide a note to the driver to indicate where along the route the number of lanes changes. The user saves the route in the command center (step 508), where the route may be later monitored as will be described below. The route is distributed to the in-vehicle navigation device (e.g., in-vehicle navigation device 206) (step 510) where the driver of the vehicle may see the route and the corresponding navigation instructions.

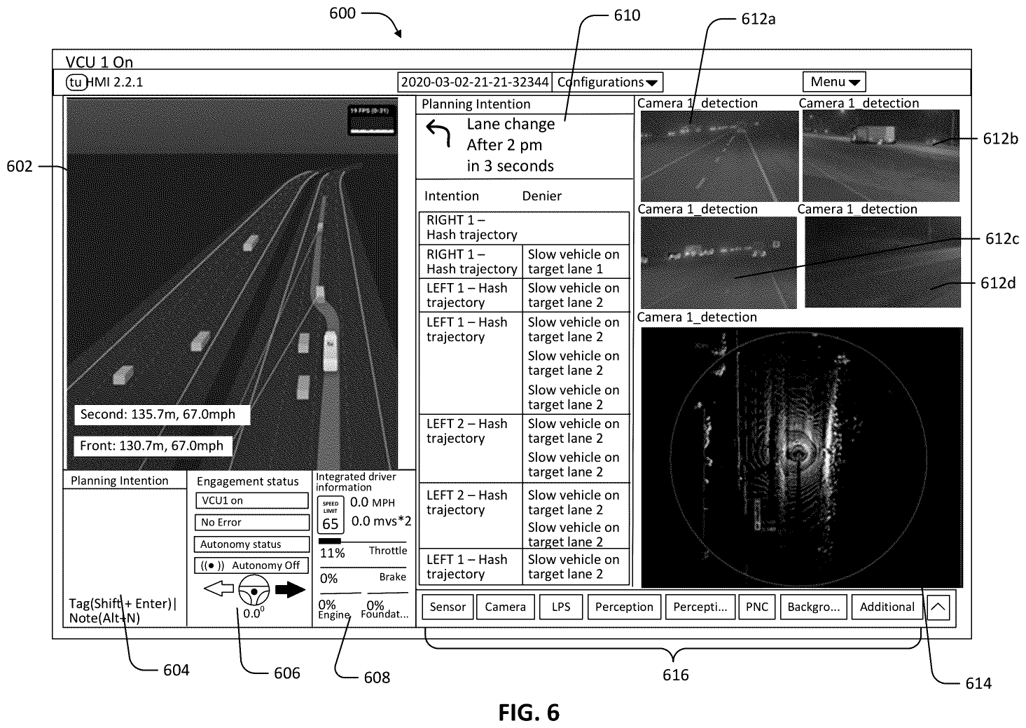

FIG. 6 shows an exemplary user interface 600 of an in-vehicle navigation device (e.g., in-vehicle navigation device 206), according to some embodiments of the present disclosure. The user interface 600 includes a map display portion 602, a notes to driver portion 604, an autonomous vehicle driving information portion 606, a current vehicle information portion 608, a navigation information portion 610, one or more camera display portions 612a-612d, a LIDAR display portion 614, and a user interface control portion 616. The map display portion 602 may include a current location of the vehicle and a portion of an area adjacent to the vehicle's current location. In the example shown in FIG. 6, the map portion 602 shows that the vehicle is on a four lane highway.

The notes to driver portion 604 may include any notes to be provided to the driver and may be keyed to the vehicle's current location such that a note will only display when the vehicle is at the location on the route associated with the note. For example, the notes may be created during the route planning as described elsewhere in this disclosure. In some embodiments, the driver may also be able to create a note to be associated with the present location of the vehicle. For example, the driver may press a button on the in-vehicle navigation device 206 (e.g., a physical button or a “soft” button on a graphical user interface of the in-vehicle navigation device). The driver-created note may be stored in the in-vehicle navigation device to be uploaded to the command center at the end of the route or may be uploaded to the command center in real-time.

The autonomous vehicle driving information portion 606 may include information relating to when the vehicle is in an autonomous driving mode. The current vehicle information portion 608 may include current vehicle information such as the posted speed limit for where the vehicle is currently located, current vehicle speed, current vehicle acceleration, and related vehicle operation information.

The navigation information portion 610 may include specific navigation directions to the vehicle driver, such as when to change lanes or to make turns. As shown in FIG. 6, the navigation directions may also include information relating to why the driver was unable to follow a particular navigation direction. For example, if the navigation direction was for the driver to change lanes at a predetermined location but was unable to change lanes because another vehicle was in the other lane at the time, that information may be logged and displayed in the navigation information portion 610.

Camera display portions 612a-612d may show what each camera located on the vehicle is capturing. As shown in FIG. 6, there are four camera display portions 612a-612d, but the number of camera display portions 612 may be changed to match the number of cameras located on the vehicle. In some embodiments, one camera display portion 612 may be included in the user interface 600 and the driver may be able to select the camera displayed from among the different cameras. Other configurations of the camera display portion 612 are possible and are within the scope of the present disclosure.

The LIDAR display portion 614 may show data captured by LIDAR sensors on the vehicle, such as displaying a LIDAR point cloud data item. The user interface portion 616 may include one or more command buttons. In some embodiments, the command buttons may be configured to select different portions of user interface 600 to highlight or to include information corresponding to the selected buttons to be displayed on the user interface 600. The user interface control portion 616 may include other graphical user interface elements to assist the driver of the vehicle in displaying information relevant to the driver's operation of the vehicle.

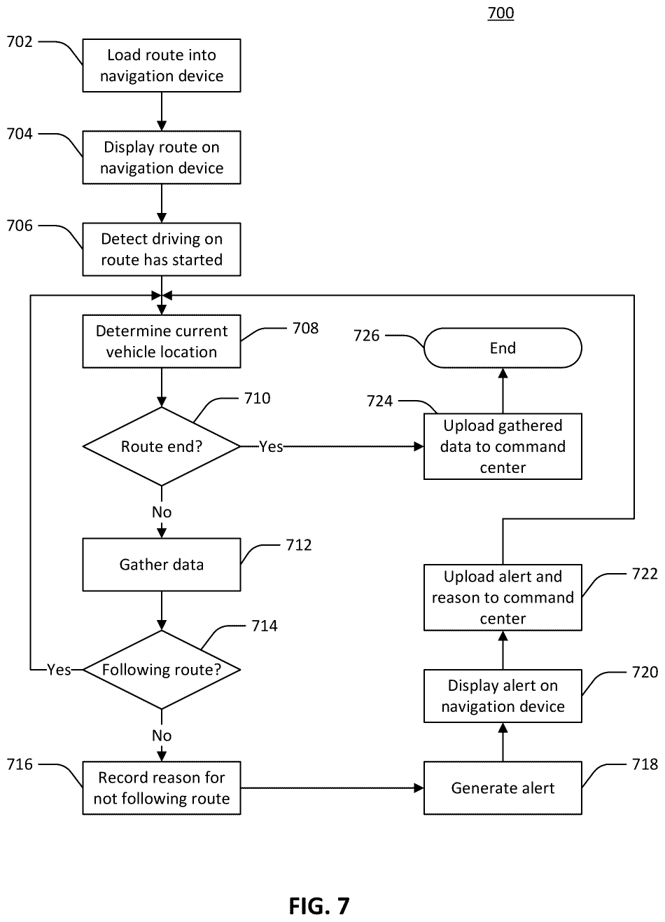

FIG. 7 shows a flowchart of an exemplary method 700 for trip monitoring, according to some embodiments of the present disclosure. The method 700 may be performed by the in-vehicle navigation device 206 in communication with the command center 204. A route to be traveled by the vehicle is loaded into the in-vehicle navigation device 206 (step 702). The route is displayed on the in-vehicle navigation device 206 (step 704). For example, the route may be displayed based on user interface 600 described above.

The device detects that the driver has started to drive the vehicle on the route (step 706). For purposes of a high definition map data collection trip, the various sensors on the vehicle are continuously gathering data. Data received by the sensors or determined by the modules of the in-vehicle navigation device 206 (e.g., a GPS sensor, positioning module 230, route detection module 232, or lane detection module 234) may be used to determine the vehicle's current location (step 708). A determination is made whether the current vehicle location indicates that the vehicle has reached the end of the planned route (step 710). If the vehicle has not reached the end of the planned route (step 710, “no” branch), then the sensor data is gathered (step 712). In some embodiments, the sensor data may be stored in the in-vehicle navigation device 206, transmitted to the command center 204 (e.g., via wireless communication between the in-vehicle navigation device 206 and the command center 204), or a combination thereof.

A determination is made whether the vehicle is following the planned route (step 714). For example, the trip monitoring module 214 or the route detection module 232 in connection with the positioning module 230 and the lane detection module 234 may determine whether the vehicle is in a lane at a location designated by the route. In some embodiments, the in-vehicle navigation device 206 may generate a periodic status message, for example, a “heartbeat” message, which includes a vehicle identifier, a timestamp, and the current vehicle location. The frequency of the status messages may be a predetermined value, for example, every one second, every two seconds, or another predetermined time interval. To determine whether a change in position has occurred, a queue (for example, a first-in, first-out (FIFO) queue) may be used to store a predetermined number of status messages (for example, ten messages). If more than a threshold number of status messages in the queue (for example, 80% or more) have the same status (for example, an indication of a lane change), then the position change is determined to have occurred at a time equal to the timestamp of the first status message that included the different vehicle position information. If fewer than the threshold number of status messages in the queue (for example, fewer than 80%) have the same status, then the position change is determined not to have occurred and the differences in the status messages may be considered as temporary noise. The size of the queue and the threshold number of status messages in the queue that need to agree before a change is determined may be user-configurable parameters.

If the vehicle is following the planned route (step 714, “yes” branch), then the method 700 loops back to step 708 to determine the vehicle's current location.

If the vehicle is not following the planned route (step 714, “no” branch), the reason for the vehicle not following the route is recorded (step 716). For example, one or more of the sensors on the vehicle may have indicated a road hazard (e.g., another vehicle, a pothole, or other road hazard) that prevented the driver from following the route. For example, if the planned route indicated that the driver was to change lanes at a certain location but the driver was prevented from changing lanes at the certain location due to a road hazard, this would indicate that the planned route is not being followed and the reason is recorded.

If the vehicle is not following the planned route, the sensors are still collecting and recording the data, but include a tag with the data (for example, the tag may be a string such as “off-route”) to indicate that the data is collected while the vehicle is off the planned route.

In some embodiments, the driver may pause the data collection, such as if the driver takes a rest break. For example, the driver may want to take a rest break and drive into a rest area on a highway. Before the driver exits the highway to enter the rest area, the driver may pause the data collection (e.g., by activating a command button in the user interface portion 616 of the in-vehicle navigation device). In such circumstances when the data collection is paused, it may not be considered a deviation from the route if the vehicle is not following the planned route. An indication may be provided to the command center 204 and an indicator may be displayed on the user interface 600 that data collection has been paused. In a similar manner, an indication may be provided to the command center 204 and an indicator may be displayed on the user interface 600 when data collection is active (e.g., at the start of a trip or when the driver restarts the data collection after a pause).

An alert that the vehicle is not following the planned route is generated (step 718). The alert is displayed on the in-vehicle navigation device 206 (step 720). For example, the alert may include an audio or visual notification presented to the user via the in-vehicle navigation device 206, e.g., a visual alert may be displayed in a top part of the navigation information portion 610 of user interface 600. The alert and the reason for the vehicle not following the planned route are uploaded to the command center 204 (step 722). By also providing this information to the command center 204, the command center 204 may be able to monitor the vehicle's progress in real-time. The method 700 then loops back to step 708 to determine the vehicle's current location.

In some embodiments, if the command center 204 is monitoring the vehicle's location in real-time, the command center 204 may make the determination whether the vehicle is following the planned route (step 714) in a manner similar to that described above. The command center 204 may also be able to determine the reason why the vehicle is not following the planned route (step 716). In such an embodiment, the alert may be generated (step 718) at the command center 204 and the alert may then be sent to the in-vehicle navigation device 206.

If the vehicle has reached the end of the planned route (step 710, “yes” branch), then the data gathered during the data gathering trip is uploaded to the command center 204 (step 724) and the method 700 terminates (step 726). In some embodiments, the data gathered by the sensors in the vehicle may be stored in the in-vehicle navigation device 206 and uploaded after the mapping trip is completed. For example, the data may be uploaded at the end of the mapping trip in case the planned route takes the vehicle to an area where it may be difficult for the in-vehicle navigation device 206 to establish a sufficiently high bandwidth connection to upload the data to the command center 204. In some embodiments, the data gathered by the sensors in the vehicle may be uploaded to the command center 204 immediately after it is gathered if there is sufficient communication bandwidth to do so at the time the data is gathered. For example, some of the gathered data may be uploaded in real-time or near real-time after being gathered, there is a break in the communication pathway (e.g., insufficient bandwidth to upload the data), and the remaining data gathered on the mapping trip may be stored in the in-vehicle navigation device 206 and then uploaded to the command center 204 after the mapping trip is completed. Other combinations of storing the gathered data in the in-vehicle navigation device 206 and the uploading data to the command center 204 are contemplated to be within the scope of the present disclosure.

In this document, the term “exemplary” is used to mean “an example of” and, unless otherwise stated, does not imply an ideal or a preferred embodiment.

Some of the embodiments described herein are described in the general context of methods or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Therefore, the computer-readable media can include a non-transitory storage media. Generally, program modules may include routines, programs, objects, components, data structures, etc. that perform particular tasks or implement particular abstract data types. Computer- or processor-executable instructions, associated data structures, and program modules represent examples of program code for executing steps of the methods disclosed herein. The particular sequence of such executable instructions or associated data structures represents examples of corresponding acts for implementing the functions described in such steps or processes.

Some of the disclosed embodiments can be implemented as devices or modules using hardware circuits, software, or combinations thereof. For example, a hardware circuit implementation can include discrete analog or digital components that are, for example, integrated as part of a printed circuit board. Alternatively, or additionally, the disclosed components or modules can be implemented as an Application Specific Integrated Circuit (ASIC) or as a Field Programmable Gate Array (FPGA) device. Some implementations may additionally or alternatively include a digital signal processor (DSP) that is a specialized microprocessor with an architecture optimized for the operational needs of digital signal processing associated with the disclosed functionalities of this application. Similarly, the various components or sub-components within each module may be implemented in software, hardware, or firmware. The connectivity between the modules or components within the modules may be provided using any one of the connectivity methods and media that is known in the art, including, but not limited to, communications over the Internet, wired, or wireless networks using the appropriate protocols.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

As used herein, unless specifically stated otherwise, the term “or” encompasses all possible combinations, except where infeasible. For example, if it is stated that a component includes A or B, then, unless specifically stated otherwise or infeasible, the component may include A, or B, or A and B. As a second example, if it is stated that a component includes A, B, or C, then, unless specifically stated otherwise or infeasible, the component may include A, or B, or C, or A and B, or A and C, or B and C, or A and B and C.

Only a few implementations and examples are described and other implementations, enhancements and variations can be made based on what is described and illustrated in this disclosure.

Implementations of the disclosure can be described in view of the following clauses, the features of which can be combined in any reasonable manner.

Clause 1. A method for route planning for high definition map data collection, comprising: selecting a portion of a digital map that includes a route to be linked to a data collection trip; drawing the route on the digital map portion using a graphical user interface tool; adding electronic navigation instructions to the route on the digital map portion; saving the route and the electronic navigation instructions to a central storage; and distributing the route and the electronic navigation instructions from the central storage to an in-vehicle navigation device of a vehicle performing the data collection trip.

Clause 2. The method of clause 1, wherein the electronic navigation instructions include lane-specific instructions for a vehicle driver.

Clause 3. The method of clauses 1 or 2, wherein the electronic navigation instructions include a note to a vehicle driver associated with a particular location on the route.

Clause 4. A system for route planning for high definition map data collection, comprising: a user console including a display and a processor configured to: select a portion of a digital map that includes a route to be linked to a data collection trip; draw the route on the digital map portion using a graphical user interface tool; add electronic navigation instructions to the route on the digital map portion; and save the route and the electronic navigation instructions to a central storage in a command center; and the command center includes a processor configured to distribute the route and the electronic navigation instructions from the central storage to an in-vehicle navigation device of a vehicle performing the data collection trip.

Clause 5. The system of clause 4, wherein the electronic navigation instructions include lane-specific instructions for a vehicle driver.

Clause 6. The system of clauses 4 or 5, wherein the electronic navigation instructions include a note to a vehicle driver associated with a particular location on the route.

Clause 7. A method for monitoring a high definition map data collection trip, comprising: determining a current vehicle location; determining whether the vehicle is following a planned route linked to a data collection trip, based on the current vehicle location; on a condition that the vehicle is not following the planned route: determining a reason why the vehicle is not following the planned route; generating an alert; displaying the alert on an in-vehicle navigation device; and uploading the alert and the reason to a command center.

Clause 8. The method of clause 7, wherein determining whether the vehicle is following the planned route includes: determining lane-specific information about the current vehicle location; comparing the lane-specific information about the current vehicle location with corresponding lane-specific information of the planned route; and determining that the vehicle is not following the planned route based on the comparison.

Clause 9. The method of clauses 7 or 8, wherein providing the alert to the in-vehicle navigation device includes any one or more of: displaying a visual alert on a display of the in-vehicle navigation device or outputting an audio signal via the in-vehicle navigation device.

Clause 10. The method of any one of clauses 7-9, further comprising: recording the reason why the vehicle is not following the planned route on the in-vehicle navigation device.

Clause 11. The method of any one of clauses 7-10, further comprising: receiving the planned route at the in-vehicle navigation device from the command center; and displaying the planned route on a display of the in-vehicle navigation device.

Clause 12. The method of any one of clauses 7-11, further comprising: gathering data along the route, wherein the gathered data includes any one or more of: image data from one or more cameras, temperature data from one or more temperature sensors, vehicle inertia data from an inertial measurement unit, global positioning system data from a global positioning system transceiver, laser range data from a laser range finder unit, or radio signal data from a radar unit.

Clause 13. The method of any one of clauses 7-12, further comprising: on a determination that the entire planned route has been driven, uploading the gathered data to the command center.

Clause 14. A system for monitoring a high definition map data collection trip, comprising: an in-vehicle navigation device including a display and a processor configured to: determine a current vehicle location; determine whether the vehicle is following a planned route linked to a data collection trip, based on the current vehicle location; on a condition that the vehicle is not following the planned route: determine a reason why the vehicle is not following the planned route; generate an alert; display the alert on the in-vehicle navigation device; and upload the alert and the reason to a command center.

Clause 15. The system of clause 14, wherein the processor is further configured to determine whether the vehicle is following the planned route by: determining lane-specific information about the current vehicle location; comparing the lane-specific information about the current vehicle location with corresponding lane-specific information of the planned route; and determining that the vehicle is not following the planned route based on the comparison.

Clause 16. The system of clauses 14 or 15, wherein the processor is further configured to provide the alert to the in-vehicle navigation device by any one or more of: displaying a visual alert on a display of the in-vehicle navigation device or outputting an audio signal via the in-vehicle navigation device.

Clause 17. The system of any one of clauses 14-16, wherein the processor is further configured to: record the reason why the vehicle is not following the planned route on the in-vehicle navigation device.

Clause 18. The system of any one of clauses 14-17, wherein the processor is further configured to: receive the planned route from the command center; and display the planned route on the display of the in-vehicle navigation device.

Clause 19. The system of any one of clauses 14-18, wherein the processor is further configured to: gather data along the route, wherein the gathered data includes any one or more of: image data from one or more cameras, temperature data from one or more temperature sensors, vehicle inertia data from an inertial measurement unit, global positioning system data from a global positioning system transceiver, laser range data from a laser range finder unit, or radio signal data from a radar unit.

Clause 20. The system of any one of clauses 14-19, wherein the processor is further configured to: upload the gathered data to the command center on a determination that the entire planned route has been driven.

1. A method for route planning for high definition map data collection, comprising:
selecting a portion of a digital map that includes a route to be linked to a data collection trip;
drawing the route on the digital map portion using a graphical user interface tool;
adding electronic navigation instructions to the route on the digital map portion;
saving the route and the electronic navigation instructions to a central storage; and
distributing the route and the electronic navigation instructions from the central storage to an in-vehicle navigation device of a vehicle performing the data collection trip.

2. The method of claim 1, wherein the electronic navigation instructions include lane-specific instructions for a vehicle driver.

3. The method of claim 1, wherein the electronic navigation instructions include a note to a vehicle driver associated with a particular location on the route.

4. A system for route planning for high definition map data collection, comprising:
a user console including a display and a processor configured to:
select a portion of a digital map that includes a route to be linked to a data collection trip;
draw the route on the digital map portion using a graphical user interface tool;
add electronic navigation instructions to the route on the digital map portion; and
save the route and the electronic navigation instructions to a central storage in a command center; and
the command center includes a processor configured to distribute the route and the electronic navigation instructions from the central storage to an in-vehicle navigation device of a vehicle performing the data collection trip.

5. The system of claim 4, wherein the electronic navigation instructions include lane-specific instructions for a vehicle driver.

6. The system of claim 4, wherein the electronic navigation instructions include a note to a vehicle driver associated with a particular location on the route.

7. A method for monitoring a high definition map data collection trip, comprising:
determining a current vehicle location;
determining whether the vehicle is following a planned route linked to a data collection trip, based on the current vehicle location;
on a condition that the vehicle is not following the planned route:
determining a reason why the vehicle is not following the planned route;
generating an alert;
displaying the alert on an in-vehicle navigation device; and
uploading the alert and the reason to a command center.

8. The method of claim 7, wherein determining whether the vehicle is following the planned route includes:
determining lane-specific information about the current vehicle location;
comparing the lane-specific information about the current vehicle location with corresponding lane-specific information of the planned route; and
determining that the vehicle is not following the planned route based on the comparison.

9. The method of claim 7, wherein providing the alert to the in-vehicle navigation device includes any one or more of: displaying a visual alert on a display of the in-vehicle navigation device or outputting an audio signal via the in-vehicle navigation device.

10. The method of claim 7, further comprising:
recording the reason why the vehicle is not following the planned route on the in-vehicle navigation device.

11. The method of claim 7, further comprising:
receiving the planned route at the in-vehicle navigation device from the command center; and
displaying the planned route on a display of the in-vehicle navigation device.

12. The method of claim 7, further comprising:
gathering data along the route, wherein the gathered data includes any one or more of: image data from one or more cameras, temperature data from one or more temperature sensors, vehicle inertia data from an inertial measurement unit, global positioning system data from a global positioning system transceiver, laser range data from a laser range finder unit, or radio signal data from a radar unit.

13. The method of claim 12, further comprising:
on a determination that the entire planned route has been driven, uploading the gathered data to the command center.

14. A system for monitoring a high definition map data collection trip, comprising:
an in-vehicle navigation device including a display and a processor configured to:
determine a current vehicle location;
determine whether the vehicle is following a planned route linked to a data collection trip, based on the current vehicle location;
on a condition that the vehicle is not following the planned route:
determine a reason why the vehicle is not following the planned route;
generate an alert;
display the alert on the in-vehicle navigation device; and
upload the alert and the reason to a command center.

15. The system of claim 14, wherein the processor is further configured to determine whether the vehicle is following the planned route by:
determining lane-specific information about the current vehicle location;
comparing the lane-specific information about the current vehicle location with corresponding lane-specific information of the planned route; and
determining that the vehicle is not following the planned route based on the comparison.

16. The system of claim 14, wherein the processor is further configured to provide the alert to the in-vehicle navigation device by any one or more of: displaying a visual alert on a display of the in-vehicle navigation device or outputting an audio signal via the in-vehicle navigation device.

17. The system of claim 14, wherein the processor is further configured to:
record the reason why the vehicle is not following the planned route on the in-vehicle navigation device.

18. The system of claim 14, wherein the processor is further configured to:
receive the planned route from the command center; and
display the planned route on the display of the in-vehicle navigation device.

19. The system of claim 14, wherein the processor is further configured to:
gather data along the route, wherein the gathered data includes any one or more of: image data from one or more cameras, temperature data from one or more temperature sensors, vehicle inertia data from an inertial measurement unit, global positioning system data from a global positioning system transceiver, laser range data from a laser range finder unit, or radio signal data from a radar unit.

20. The system of claim 19, wherein the processor is further configured to:
upload the gathered data to the command center on a determination that the entire planned route has been driven.
